(19) United States
(12) Patent Application Publication
(10) Pub. No.: US 2011/0316870 A1
(43) Pub. Date: Dec. 29, 2011

(54) METHOD FOR PROVIDING A USER WITH A FAST CONTROL USER INTERFACE, AND ASSOCIATED ELECTRONIC DEVICE

(76) Inventor: Chun Jiang, Anhui (CN)

(21) Appl. No.: 12/812,235

(22) PCT Filed: Jun. 7, 2010
(86) PCT No.: PCT/CN10/73616

§ 371 Date: Jul. 9, 2010

(51) Int. Cl. G09G 5/02

(52) U.S. Cl. 345/589

(57) ABSTRACT

A method for providing a user with a fast control user interface includes: providing the user with a plurality of keys/buttons for selecting one of a plurality of display regions on a screen, where each display region corresponds to at least one associated key/button of the keys/buttons; and when a specific key/button of the keys/buttons is pressed, selecting/highlighting a specific display region corresponding to the specific key/button for further operations. An associated electronic device is further provided, where the electronic device includes: an interface circuit arranged to receive signals directly/indirectly from the plurality of keys/buttons, where the electronic device or at least one accessory thereof provides the user with the plurality of keys/buttons for selecting one of the plurality of display regions on the screen; and a control circuit arranged to provide the user with the fast control user interface.

### TECHNICAL FIELD

The present invention relates to convenient cursor control of an electronic device that does not need to have a mouse, and more particularly, to a method for providing a user with a fast control user interface, and to an associated electronic device.

### BACKGROUND

In some related art systems that are not properly designed, in a situation where there is no mouse available, array keys are typically utilized for moving a cursor displayed on a screen. As a result, when long distance movement of the cursor is required, it takes a long time for the user to press one or more array keys, causing inconvenience to the user who is using the related art systems. Some proposals provided in the related art in response to this problem would probably be helpful. However, corresponding side effects are introduced. Thus, a novel method is required for enhancing the user interface to provide convenient cursor control.

### SUMMARY

It is therefore an objective of the claimed invention to provide a method for providing a user with a fast control user interface, and to provide an associated electronic device, in order to solve the above-mentioned problem.

It is another objective of the claimed invention to provide a method for providing a user with a fast control user interface, and to provide an associated electronic device, in order to implement convenient cursor control by utilizing keys and/or buttons. As a result of applying the present invention method, the user can easily control movement of a cursor displayed on a screen, and more particularly, long distance movement thereof, having no need to utilize a pointing device such as a mouse, a pointing stick, a touchpad, or a touch screen.

An exemplary embodiment of a method for providing a user with a fast control user interface is provided, where the method is applied to an electronic device, and the method comprises: providing the user with a plurality of keys/buttons for selecting one of a plurality of display regions on a screen, wherein each display region corresponds to at least one associated key/button of the keys/buttons; and when a specific key/button of the keys/buttons is pressed, selecting/highlighting a specific display region corresponding to the specific key/button for further operations.

An exemplary embodiment of an electronic device comprises a control circuit and an interface circuit. The control circuit is arranged to control operations of the electronic device and to provide a user with a fast control user interface. In addition, the interface circuit is arranged to receive signals directly/indirectly from a plurality of keys/buttons and to notify the control circuit of user activities accordingly, wherein the electronic device or at least one accessory thereof provides the user with the plurality of keys/buttons for selecting one of a plurality of display regions on a screen, and each display region corresponds to at least one associated key/button of the keys/buttons. Additionally, when a specific key/button of the keys/buttons is pressed, the control circuit selects/highlights a specific display region corresponding to the specific key/button for further operations.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an electronic device capable of providing a user with a fast control user interface according to a first embodiment of the present invention.

FIGS. 2A-2C illustrate some examples of the electronic device shown in FIG. 1 according to different special cases of the first embodiment.

FIG. 3 is a flowchart of a method for providing a user with a fast control user interface according to an embodiment of the present invention.

FIG. 4 illustrates an exemplary geographic arrangement of a plurality of display regions involved with the method shown in FIG. 3.

FIG. 5 illustrates a plurality of display regions on a screen according to an embodiment of the present invention, where this embodiment is a special case of the embodiment shown in FIG. 3.

FIG. 6 illustrates a plurality of sub-regions of a specific display region of the plurality of display regions shown in FIG. 5.

FIG. 7 illustrates some exemplary selectable items involved with the method shown in FIG. 3 according to an embodiment of the present invention.

FIG. 8 illustrates an exemplary zoom in operation result of the specific display region according to a variation of the embodiment shown in FIG. 6.

FIG. 9 illustrates an exemplary zoom in operation result of the specific display region according to another variation of the embodiment shown in FIG. 6.

FIG. 10 illustrates an exemplary geographic arrangement of a plurality of display regions involved with the method shown in FIG. 3 according to a variation of the embodiment shown in FIG. 4.

FIG. 11 illustrates an exemplary geographic arrangement of a plurality of sub-regions involved with the method shown in FIG. 3 according to the embodiment shown in FIG. 10.

FIGS. 12A-12C respectively illustrate some exemplary geographic arrangements of a plurality of sub-regions involved with the method shown in FIG. 3 according to other variations of the embodiment shown in FIG. 4.

FIG. 13 illustrates an exemplary geographic arrangement of a plurality of display regions involved with the method shown in FIG. 3 according to another variation of the embodiment shown in FIG. 4.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

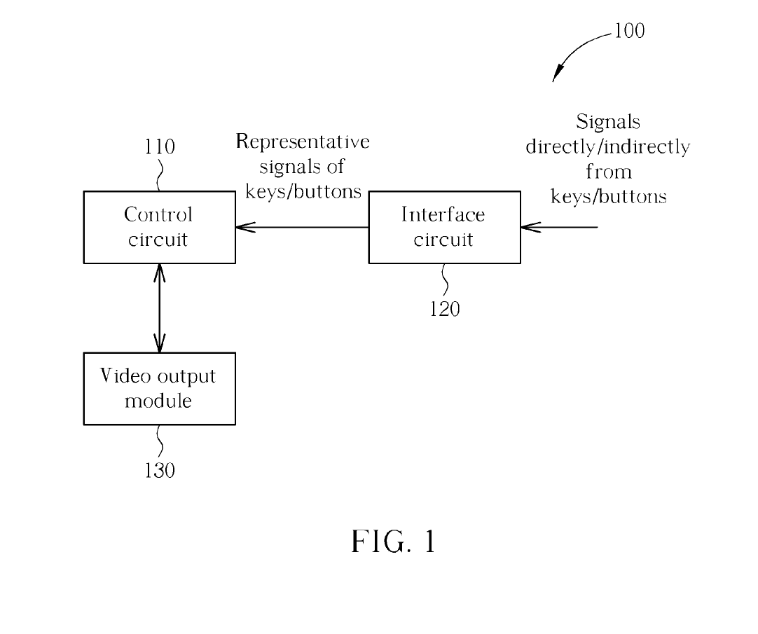

Please refer to FIG. 1, which illustrates a block diagram of an electronic device 100 capable of providing a user with a fast control user interface according to a first embodiment of the present invention. The electronic device 100 comprises a control circuit 110, an interface circuit 120, and a video output module 130. The control circuit 110 is arranged to control operations of the electronic device 100 and to provide the user with the fast control user interface. In addition, the interface circuit 120 is arranged to receive signals directly/indirectly from a plurality of keys/buttons and to notify the control circuit 110 of user activities accordingly by transmitting representative signals of the keys/buttons to the control circuit 110. Please note that implementation of the video output module 130 may varies according to different embodiments of the present invention. For example, the video output module 130 can be a display module, such as a liquid crystal display (LCD) panel, a plasma display panel (PDP) panel, or a projector module. In another example, the video output module 130 can be a video output circuit arranged to output video signals to a display device (e.g. an LCD monitor, a PDP monitor, or a projector) coupled to the electronic device 100.

According to some embodiments of the present invention, such as the first embodiment or other embodiments disclosed below, the electronic device 100 or at least one accessory thereof (e.g. a remote controller of the electronic device 100, or a keypad of the electronic device 100, or various kinds of peripheral devices of the electronic device 100) provides the user with the plurality of keys/buttons for selecting one of a plurality of display regions on a screen (e.g. a screen on the display module/device such as the LCD panel, the PDP panel, the LCD monitor, or the PDP monitor mentioned above, or a screen projected by the display module/device such as the projector module or the projector mentioned above), and each display region corresponds to at least one associated key/button of the keys/buttons. For example, the interface circuit 120 can be a signal interfacing circuit arranged to convert key press detection signals of the keys/buttons of the electronic device 100 into the representative signals of the keys/buttons of the electronic device 100. In another example, the interface circuit 120 can be a wired connection interface circuit arranged to establish a wired connection between the electronic device 100 and the accessory thereof in order to transmit the representative signals of the keys/buttons on the accessory to the control circuit 110. In another example, the interface circuit 120 can be a wireless connection interface circuit arranged to establish a wireless connection between the electronic device 100 and the accessory thereof in order to transmit the representative signals of the keys/buttons on the accessory to the control circuit 110.

According to the embodiments, no matter whether the keys/buttons are implemented within the electronic device 100 or implemented on any accessory of the electronic device 100, when a specific key/button of the keys/buttons is pressed, the control circuit 110 can select or highlight a specific display region corresponding to the specific key/button for further operations. In addition, as the electronic device 100 can provide the user with the fast control user interface by utilizing the existing keys/buttons of the electronic device 100 or the accessory thereof, and as associated operations of effective selection or non-effective selection (whose meanings will be explained in the following) can be performed in a similar manner for sub-regions on the screen, the need for utilizing a pointing device such as a mouse, a pointing stick, a touchpad, or a touch screen can be eliminated. However, this by no means implies that the electronic device 100 in the embodiments absolutely cannot be equipped with any pointing device. For example, the electronic device 100 of some embodiments may have at least one pointing device implemented as an accessory or implemented as a portion of the electronic device 100 and provide the user with the fast control user interface at the same time.

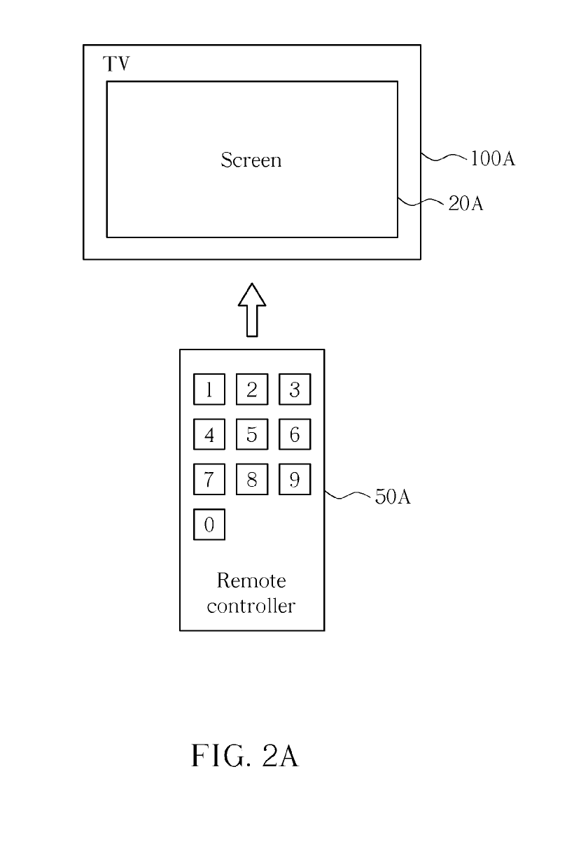

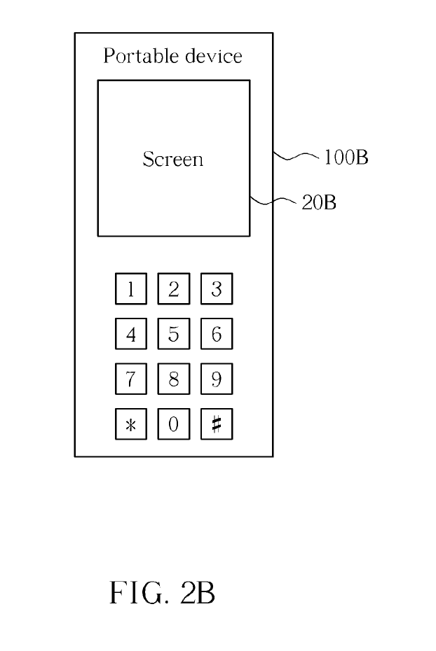

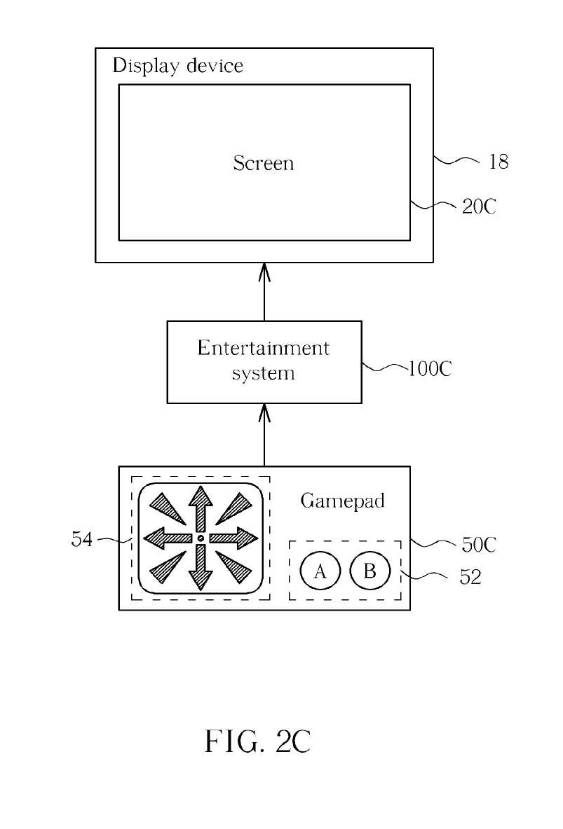

FIGS. 2A-2C illustrate some examples of the electronic device 100 shown in FIG. 1 according to different special cases of the first embodiment. As shown in FIG. 2A, the electronic device 100 can be a television (TV) 100A such as an LCD TV or a PDP TV, where the aforementioned screen is the screen 20A of the TV 100A, and the plurality of keys/buttons mentioned above can be those implemented on the remote controller 50A shown in the lower half of FIG. 2A. This is for illustrative purposes only, and is not meant to be a limitation of the present invention. According to a variation of the embodiment shown in FIG. 2A, the plurality of keys/buttons mentioned above can be those implemented on the TV 100A. According to another variation of the embodiment shown in FIG. 2A, the electronic device 100 can be a monitor 100A′ (not shown) such as an LCD monitor or a PDP monitor, where the plurality of keys/buttons mentioned above can be those implemented on the monitor 100A′, or those implemented on the remote controller thereof if it exists. According to another variation of the embodiment shown in FIG. 2A, the electronic device 100 can be a home theater system (or a subsystem thereof), where the plurality of keys/buttons mentioned above can be those implemented on the home theater system (or the subsystem thereof), or those implemented on the remote controller thereof if it exists.

In the embodiment shown in FIG. 2B, the electronic device 100 can be a portable device 100B such as a mobile phone, a personal digital assistant (PDA), a multimedia player, or a portable electronic device having multiple functions (e.g. mobile phone functions, PDA functions, and/or multimedia player functions), where the aforementioned screen is the screen 20B of the portable device 100B, and the plurality of keys/buttons mentioned above can be those implemented within the portable device 100B. In the embodiment shown in FIG. 2C, the electronic device 100 can be an entertainment system 100C such as a video game device, where the aforementioned screen is the screen 20C of a display device 18 coupled to the entertainment system 100C, and the plurality of keys/buttons mentioned above can be those implemented on the gamepad 50C shown in the bottommost of FIG. 2C, and more particularly, the action buttons 52 (respectively labeled “A” and “B” in FIG. 2C) and/or the multiple direction buttons implemented (or combined) within the direction controller 54.

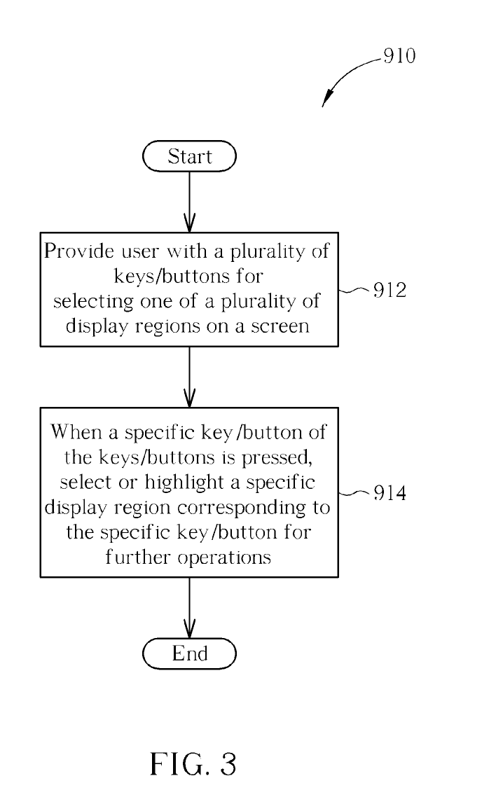

FIG. 3 is a flowchart of a method 910 for providing a user with a fast control user interface according to an embodiment of the present invention. The method can be applied to the electronic device 100 shown in FIG. 1, and more particularly, to the control circuit 110 mentioned above. In addition, the method can be implemented by utilizing the electronic device 100 shown in FIG. 1, and more particularly, by utilizing the control circuit 110 mentioned above. The method 910 is described as follows.

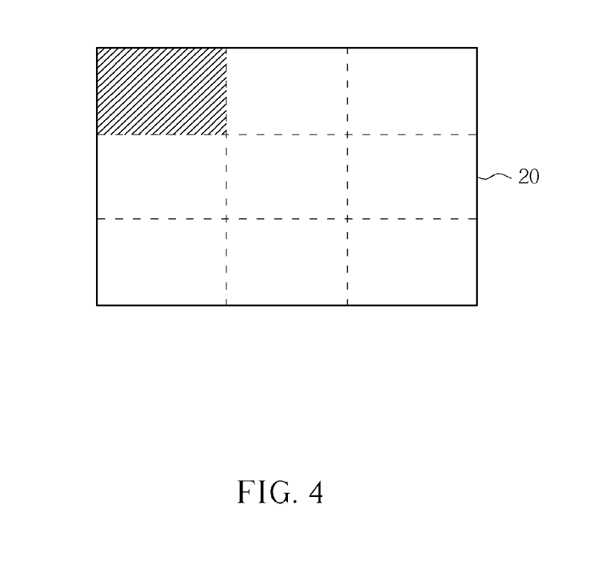

In Step 912, the electronic device 100 or at least one accessory thereof provides the user with a plurality of keys/buttons for selecting one of a plurality of display regions on a screen, such as the display regions mentioned above, where each display region corresponds to at least one associated key/button (e.g. one or more associated keys/buttons) of the keys/buttons. For example, the keys/buttons are those implemented within the electronic device 100, such as the keys/buttons shown in FIG. 2B. In another example, the keys/buttons are implemented on at least one accessory of the electronic device 100, such as the remote controller 50A or the gamepad 50C. Here, an exemplary geographic arrangement of the display regions is illustrated in FIG. 4 with the screen 20 representing the aforementioned screen such as the screen 20A, the screen 20B, or the screen 20C.

In Step 914, when a specific key/button of the keys/buttons is pressed, the control circuit 110 selects or highlights a specific display region corresponding to the specific key/button for further operations. For example, the control circuit 110 directly selects the specific display region in response to the user selection represented by the key press, where the user selection is regarded as effective selection since no further confirmation (e.g. another key press representing “OK” or “Enter”) is required. In another example, the control circuit 110 highlights the specific display region for further operations in response to the non-effective selection represented by the key press, and waits for further confirmation from the user, where the non-effective selection can be performed one or more times. In particular, the control circuit 110 can make the specific display region (e.g. the shaded display region shown in FIG. 4) blink for a while in Step 914, in order to notify the user of the receiving the key press that represents the user selection (i.e. the effective selection) or the non-effective selection.

Taking the numeral keys on the remote controller 50A shown in FIG. 2A as an example, the geographic arrangement of the display regions shown in FIG. 4 corresponds to the arrangement of the plurality of keys/buttons, such as the numeral keys 1-9. That is, the upper left display region corresponds to the numeral key 1, the next display region within the uppermost row of display regions shown in FIG. 4 corresponds to the numeral key 2, and the upper right display region corresponds to the numeral key 3. Subsequently, in the second row of display regions shown in FIG. 4, the leftmost display region corresponds to the numeral key 4, the next display region corresponds to the numeral key 5, and the rightmost display region corresponds to the numeral key 6. Similarly, the bottom left display region corresponds to the numeral key 7, the next display region within the bottommost row of display regions shown in FIG. 4 corresponds to the numeral key 8, and the bottom right display region corresponds to the numeral key 9. For example, in a situation where the specific key/button mentioned in Step 914 is the numeral key 1, the control circuit 110 selects or highlights the upper left display region. In another example, in a situation where the specific key/button mentioned in Step 914 is the numeral key 5, the control circuit 110 selects or highlights the central display region in the second row of di splay regions.

More particularly, the operations of Step 912 can be performed in a similar manner for sub-regions on the screen, such as sub-regions of any of the display regions, or a portion of sub-regions within any of the display regions. The electronic device 100 or the aforementioned accessory thereof further provides the user with a set of keys/buttons for selecting one of a plurality of sub-regions of the specific display region. Please note that the set of keys/buttons are not necessarily to be the same as the plurality of keys/buttons mentioned above, and each sub-region corresponds to at least one associated key/button of the set of keys/buttons. For example, the set of keys/buttons comprise at least one portion of the plurality of keys/buttons. In another example, the set of keys/buttons are the same as the plurality of keys/buttons.

In addition, when a key/button of the set of keys/buttons is pressed, the control circuit 110 selects or highlights a specific sub-region corresponding to the pressed key/button of the set of keys/buttons for further operations. For example, the control circuit 110 directly selects the specific sub-region corresponding to the pressed key/button of the set of keys/buttons in response to the user selection represented by the key press, where the user selection is regarded as effective selection since no further confirmation is required. In another example, the control circuit 110 highlights the specific sub-region corresponding to the pressed key/button of the set of keys/buttons in response to the non-effective selection represented by the key press, and waits for further confirmation from the user, where the non-effective selection can be performed one or more times. As a result of applying the method 910 shown in FIG. 3, the user can easily control movement of a cursor displayed on the screen, and more particularly, long distance movement thereof, having no need to utilize a pointing device such as a mouse, a pointing stick, a touchpad, or a touch screen.

Please note that the display regions shown in FIG. 4 are substantially obtained by trisecting the whole area of the screen 20 in both the horizontal direction and the vertical direction. This is for illustrative purposes only, and is not meant to be a limitation of the present invention. According to variations of this embodiment, the number of display regions and/or the geographic arrangement of the display regions can be varied. For example, the geographic arrangement of the display regions may correspond to the arrangement of the keys/buttons, where the keys/buttons can be arbitrarily arranged, rather than being arranged in a three-by-three array as disclosed by the numeral keys 1-9 shown in FIG. 2A. In another example, the geographic arrangement of the display regions may correspond to an arrangement of webpage contents displayed on the screen.

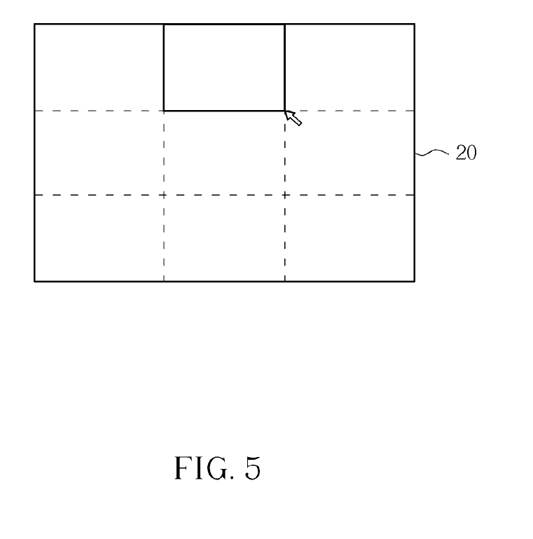

FIG. 5 illustrates a plurality of display regions on the screen 20 (e.g. the display regions mentioned in Step 912) according to an embodiment of the present invention, where this embodiment is a special case of the embodiment shown in FIG. 3, and is a variation of the embodiment shown in FIG. 4. In a situation where the control circuit 110 merely highlights the specific display region in Step 914, rather than directly selecting the specific display region, the control circuit 110 can highlight the specific display region in Step 914 by utilizing bold edges encircling the specific display region. In addition, a moveable icon such as the arrowhead icon shown in FIG. 5 can be regarded as a cursor, and can be dynamically displayed for pointing to the specific display region in order to strengthen the visual effect of highlighting the specific display region. This is for illustrative purposes only, and is not meant to be a limitation of the present invention. According to a variation of the embodiment shown in FIG. 5, when the specific key/button of the plurality of keys/buttons is pressed, the control circuit 110 can highlight the specific display region corresponding to the specific key/button by highlighting one or more selectable items (e.g. hyperlinks, virtual buttons, etc.) of the specific display region, such as one or more selectable items displayed within the specific display region.

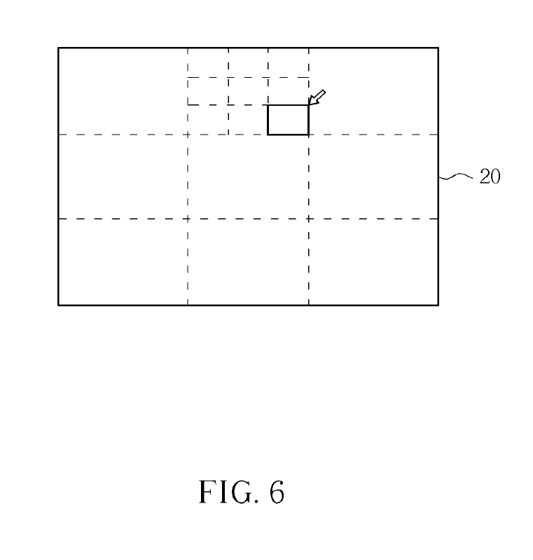

FIG. 6 illustrates a plurality of sub-regions of the specific display region of the plurality of display regions shown in FIG. 5, such as the sub-regions mentioned in the embodiment shown in FIG. 3. Similarly, in a situation where the control circuit 110 merely highlights the specific sub-region, rather than directly selecting the specific sub-region, the control circuit 110 can highlight the specific sub-region by utilizing bold edges encircling the specific sub-region. In addition, the aforementioned moveable icon such as the arrowhead icon shown in FIG. 6 can be regarded as the cursor, and can be dynamically displayed for pointing to the specific sub-region in order to strengthen the visual effect of highlighting the specific sub-region. This is for illustrative purposes only, and is not meant to be a limitation of the present invention. According to a variation of this embodiment, such as the aforementioned variation of the embodiment shown in FIG. 5, when the key/button of the set of keys/buttons is pressed, the control circuit 110 can highlight the specific sub-region corresponding to the pressed key/button of the set of keys/buttons by highlighting one or more selectable items (e.g. hyperlinks, virtual buttons, etc.) of the specific sub-region, such as one or more selectable items displayed within the specific sub-region.

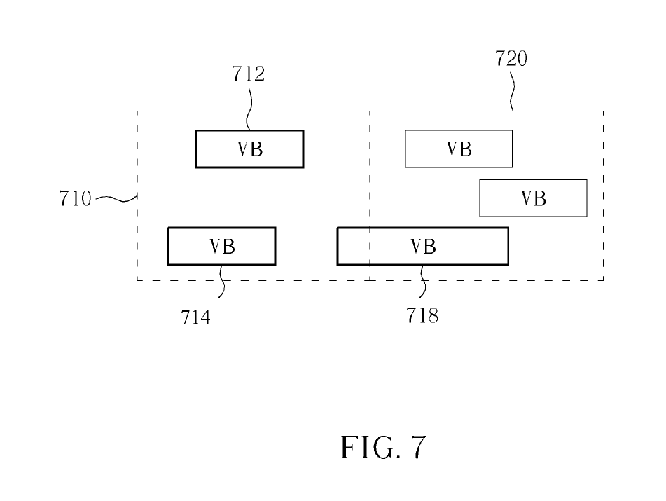

FIG. 7 illustrates some exemplary selectable items involved with the method 910 shown in FIG. 3 according to an embodiment of the present invention, such as the aforementioned variation of the embodiment shown in FIG. 5. Here, virtual buttons are taken as examples of the selectable items. As shown in FIG. 7, the selectable items 712 and 714 are fully positioned within the region 710, and are labeled “VB”, which means they are virtual buttons. In addition, the selectable item 718 is partially positioned within the region 710 and partially positioned within the region 720, and is also labeled “VB”, which means it is also a virtual button. Additionally, the other selectable items shown in FIG. 7, i.e. the upper two virtual buttons (labeled “VB”) in the region 720, are positioned outside the region 710.

Please note that the regions 710 and 720 may represent display regions or sub-regions. For example, the region 710 may represent the aforementioned specific display region that is highlighted, and the region 720 may represent a non-highlighted display region. In another example, the region 710 may represent the aforementioned specific sub-region that is highlighted, and the region 720 may represent a non-highlighted sub-region. No matter whether the region 710 represents the specific display region or the specific sub-region, the control circuit 110 can highlight the selectable items involved with the region 710, such as the selectable items 712, 714, and 718 that may be fully or partially positioned within the region 710 in this embodiment, by blinking operations applied to these selectable items. This is for illustrative purposes only, and is not meant to be a limitation of the present invention. According to a variation of this embodiment, the control circuit 110 highlights only those fully positioned within the region 710, i.e. the selectable items 712 and 714, rather than the selectable item 718 that is partially positioned within the region 710. According to another variation of this embodiment, the control circuit 110 can highlight the selectable items of the specific display region or the specific sub-region by changing the colors or shapes of these selectable items.

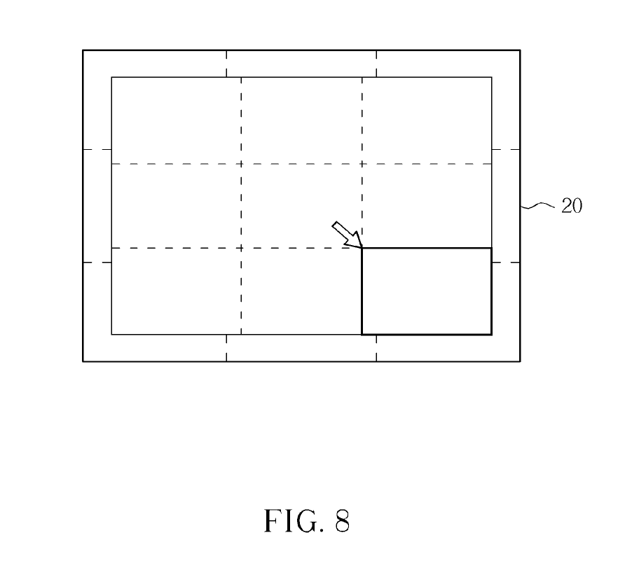

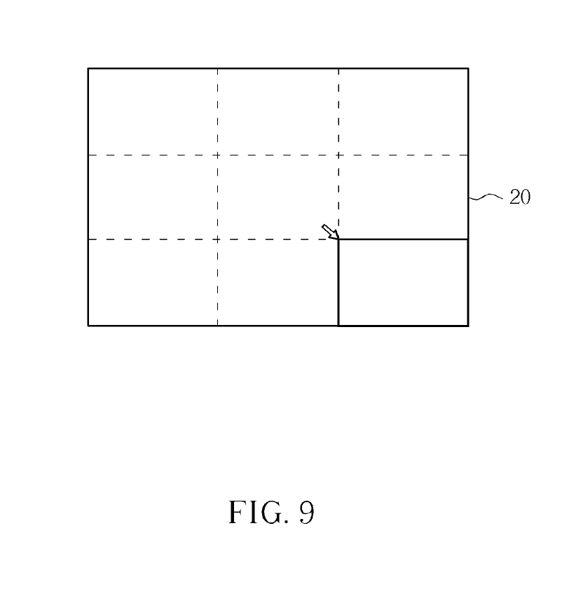

Please note that the size and the location of the specific display region involved with the embodiment shown in FIG. 6 are kept unvaried with regard to those disclosed in FIG. 5. This is for illustrative purposes only, and is not meant to be a limitation of the present invention. According to a variation of this embodiment, when the specific key/button is pressed, the control circuit 110 performs a zoom in operation by enlarging the contents of the specific display region for the user's convenience. More particularly, the control circuit 110 can enlarge the contents of the specific display region with a predetermined enlarging factor, such as a positive value that is greater than one. For example, in a situation where the predetermined enlarging factor falls within a range of [2.1, 2.9], the control circuit 110 enlarges the specific display region and the sub-regions thereof as shown in FIG. 8 (together with the contents therein), and further controls the enlarged contents of the specific display region to be displayed on an upper layer of the original layer of the plurality of display regions shown in FIG. 5. In another example, in a situation where the predetermined enlarging factor is equal to three, the control circuit 110 enlarges the specific display region and the sub-regions thereof as shown in FIG. 9 (together with the contents therein), and further controls the enlarged contents of the specific display region to be displayed on the whole screen 20. As a result, the enlarged contents of the specific display region replace the contents of the plurality of display regions shown in FIG. 5.

More particularly, in some embodiments such as one or more of those shown in FIG. 8 and FIG. 9, when the key/button of the set of keys/buttons mentioned above is pressed, the control circuit 110 can further perform a zoom in operation by enlarging the contents of the specific sub-region for the user's convenience. Similar descriptions are not repeated in detail for the case of the specific sub-region since the operations can be performed in a similar manner.

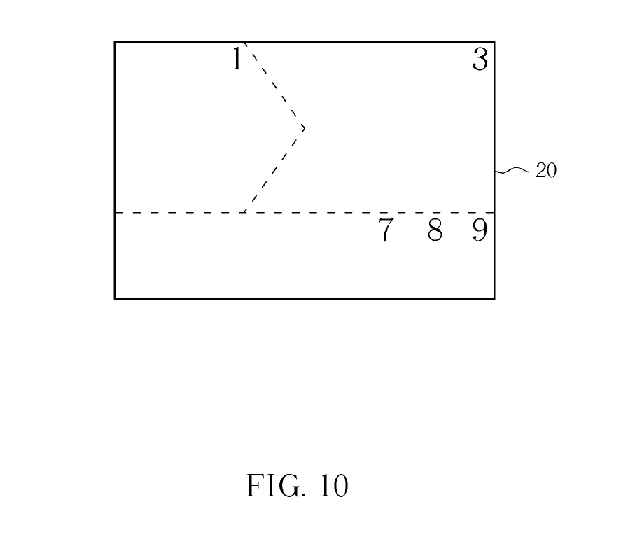

FIG. 10 illustrates an exemplary geographic arrangement of a plurality of display regions involved with the method 910 shown in FIG. 3 according to a variation of the embodiment shown in FIG. 4, where the geographic arrangement of the display regions corresponds to an arrangement of the keys/buttons. As the plurality of display regions shown in FIG. 10 are not obtained by trisecting the whole area of the screen 20 in both the horizontal direction and the vertical direction, with regard to the respective display regions of this embodiment, the control circuit 110 provides the user with associated visual indexes displayed on the screen 20, where the visual indexes respectively correspond to the keys/buttons. Taking the numeral keys on the remote controller 50A shown in FIG. 2A as an example, the geographic arrangement of the display regions shown in FIG. 10 corresponds to the arrangement of the plurality of keys/buttons, such as the numeral keys 1-9. That is, the upper left display region corresponds to the numeral key 1, the upper right display region corresponds to the numeral key 3, and the bottommost display region corresponds to the numeral keys 7-9. Thus, the visual index depicting the number 1 is displayed in the upper left display region, the visual index depicting the number 3 is displayed in the upper right display region, and the visual indexes respectively depicting the numbers 7-9 are displayed in the bottommost display region. This is for illustrative purposes only, and is not meant to be a limitation of the present invention. According to variations of the embodiment shown in FIG. 10, the visual indexes may depict numbers, characters, and/or symbols represented by the keys/buttons, respectively. In some variations of the embodiment shown in FIG. 10, the visual indexes may respectively depict colors of the keys/buttons, colors of respective surroundings of the keys/buttons, colors of labels of the keys/buttons, colors of marks of the keys/buttons, colors of light emitted from the keys/buttons, and/or colors of light emitted from respective surroundings of the keys/buttons. For example, the control circuit 110 utilizes the respective edges encircling the display regions (i.e. the edges that respectively encircle the display regions) as the visual indexes respectively depicting the respective colors of the keys/buttons, and displays the respective edges of the display regions with the respective colors of the keys/buttons. In another example, the control circuit 110 utilizes the respective selectable items (e.g. hyperlinks, virtual buttons, etc.) of the display regions as the visual indexes respectively depicting the respective colors of the keys/buttons, and displays the respective selectable items of the display regions with the respective colors of the keys/buttons.

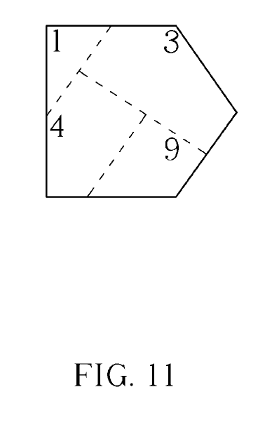

FIG. 11 illustrates an exemplary geographic arrangement of a plurality of sub-regions involved with the method 910 shown in FIG. 3 according to the embodiment shown in FIG. 10, where the geographic arrangement of the sub-regions corresponds to an arrangement of the keys/buttons. Taking the upper left display region shown in FIG. 10 as an example of the specific display region mentioned above, the control circuit 110 divides the specific display region into the sub-regions as shown in FIG. 11. Similarly, the upper left sub-region corresponds to the numeral key 1, the upper right sub-region corresponds to the numeral key 3, the leftmost sub-region corresponds to the numeral key 4, and the bottom right sub-region corresponds to the numeral key 9. Thus, the visual index depicting the number 1 is displayed in the upper left sub-region, the visual index depicting the number 3 is displayed in the upper right sub-region, the visual index depicting the number 4 is displayed in the leftmost sub-region, and the visual index depicting the number 9 is displayed in the bottom right sub-region. According to some embodiments, such as the aforementioned variations of the embodiment shown in FIG. 10, the visual indexes respectively depicting numbers, characters, and/or symbols represented by the keys/buttons, or the visual indexes respectively depicting colors of the keys/buttons, colors of respective surroundings of the keys/buttons, colors of labels of the keys/buttons, colors of marks of the keys/buttons, colors of light emitted from the keys/buttons, and/or colors of light emitted from respective surroundings of the keys/buttons, can also be applied to the sub-regions.

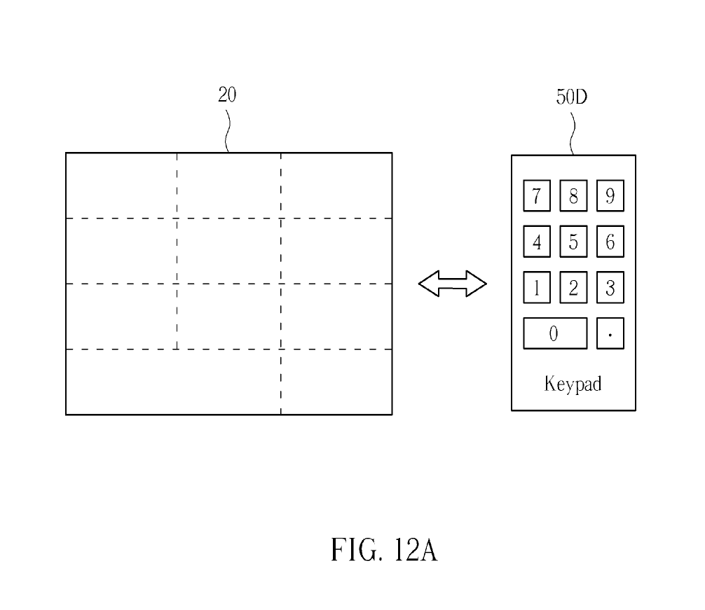

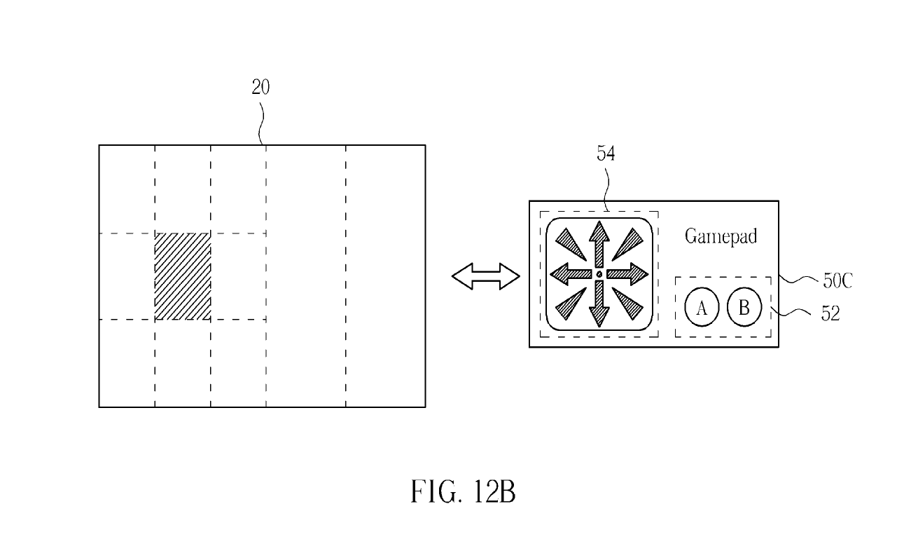

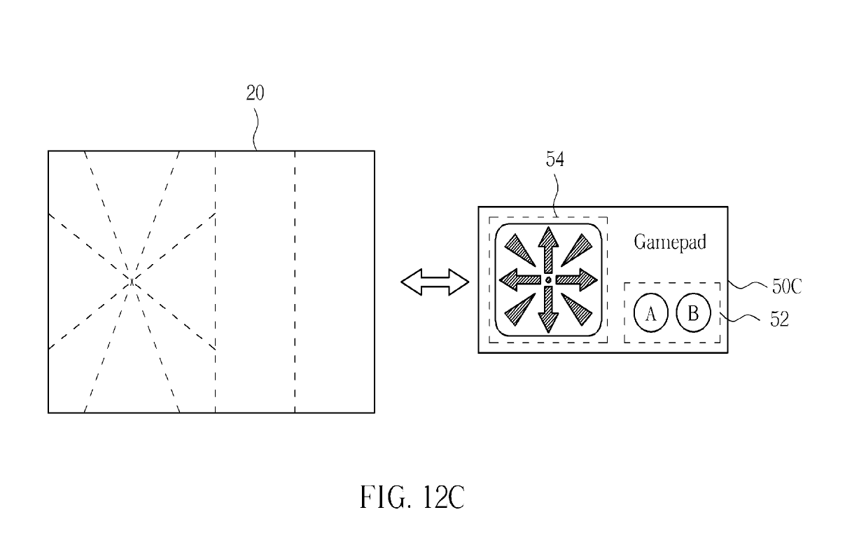

FIG. 12A illustrates an exemplary geographic arrangement of a plurality of sub-regions involved with the method 910 shown in FIG. 3 according to another variation of the embodiment shown in FIG. 4. The geographic arrangement of the display regions shown in the left half of FIG. 12A corresponds to an arrangement of the keys/buttons on the keypad 50D shown in the right half of FIG. 12A. More specifically, the bottom left display region on the screen 20 corresponds to the numeral key 0, and the bottom right display region on the screen 20 corresponds to the dot key. In addition, the other display regions on the screen 20 correspond to the numeral keys 1-9, respectively. Please note that the bottom left display region on the screen 20 has a larger area than others since the size of the numeral key 0 of the keypad 50D is greater than that of any of the other keys shown in FIG. 12A. Similar descriptions are not repeated in detail for this variation.

FIG. 12B illustrates an exemplary geographic arrangement of a plurality of sub-regions involved with the method 910 shown in FIG. 3 according to another variation of the embodiment shown in FIG. 4. The geographic arrangement of the display regions shown in the left half of FIG. 12B corresponds to an arrangement of the keys/buttons on the gamepad 50C shown in the right half of FIG. 12B. The two display regions on the right side of the screen 20 correspond to the action buttons 52, and more particularly, the two action buttons respectively labeled “A” and “B”, while at least a portion of the other display regions on the screen 20 correspond to the aforementioned multiple direction buttons implemented (or combined) within the direction controller 54. For example, in a situation where there is no central button available among the multiple direction buttons implemented (or combined) within the direction controller 54, the control circuit 110 can temporarily highlight the shaded region shown in the left half of FIG. 12B at first, and wait for further confirmation (e.g. a simultaneous key press of the action buttons 52 (respectively labeled “A” and “B”), which represents “OK” or “Enter” here). In another example, in a situation where the central button is implemented among the multiple direction buttons implemented (or combined) within the direction controller 54, the control circuit 110 has no need to temporarily highlight the shaded region shown in the left half of FIG. 12B. Similar descriptions are not repeated in detail for this variation.

FIG. 12C illustrates an exemplary geographic arrangement of a plurality of sub-regions involved with the method 910 shown in FIG. 3 according to another variation of the embodiment shown in FIG. 4. The geographic arrangement of the display regions shown in the left half of FIG. 12C corresponds to an arrangement of the keys/buttons on the gamepad 50C shown in the right half of FIG. 12C. For example, in a situation where there is no central button available among the aforementioned multiple direction buttons implemented (or combined) within the direction controller 54, the control circuit 110 has no need to temporarily highlight any display region at first as disclosed in the embodiment shown in FIG. 12B. In another example, in a situation where the central button is implemented among the aforementioned multiple direction buttons implemented (or combined) within the direction controller 54, the control circuit 110 still has no need to temporarily highlight any display region at first as disclosed in the embodiment shown in FIG. 12B, and the central button is intentionally omitted when implementing the fast control user interface here. Similar descriptions are not repeated in detail for this variation.

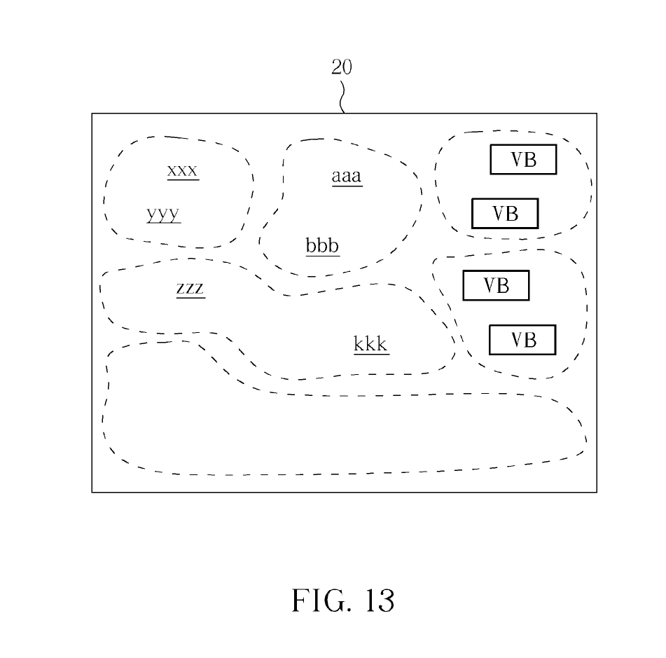

FIG. 13 illustrates an exemplary geographic arrangement of a plurality of display regions involved with the method 910 shown in FIG. 3 according to another variation of the embodiment shown in FIG. 4, where the geographic arrangement of the display regions shown in FIG. 13 corresponds to the arrangement of the webpage contents displayed on the screen 20, and more particularly, the arrangement of the selectable items displayed on the screen 20. For simplicity, exemplary text strings such as “xxx”, “yyy”, “zzz”, “kkk”, “aaa”, and “bbb” are taken as an example of selectable items such as hyperlinks. In addition, some virtual buttons (labeled “VB”) are illustrated in the upper right display region and the rightmost display region shown in FIG. 13, respectively.

In this variation, the bottommost display region has no selectable item therein, while the other display regions respectively have selectable items (e.g. hyperlinks, virtual buttons, etc.) therein. For example, within those display regions having selectable items therein, the number of selectable items in a second display region can be approximately the same as the number of selectable items in a first display region. In another example, within those display regions having selectable items therein, the number of selectable items in a third display region can be exactly the same as the number of selectable items in the second display region. Thus, the control circuit 110 controls the respective numbers of selectable items in those display regions having selectable items therein to be the same or almost the same. In particular, the control circuit 110 controls the respective numbers of selectable items in those display regions having selectable items therein to be small. As a result, the user can utilize the fast control user interface with ease since each display regions will not have too many selectable items.

In addition, for the user's convenience, the control circuit 110 of this variation can utilizes the respective selectable items of the display regions as the visual indexes respectively depicting the respective colors of the keys/buttons, and displays the respective selectable items of the display regions with the respective colors of the keys/buttons. Similar descriptions are not repeated in detail for this variation.

In general, the sub-regions mentioned above can be regarded as display regions of the aforementioned screen in one or more of the embodiments/variations disclosed above.

It is an advantage of the present invention that the present invention method and the associated electronic device can provide the user with the fast control user interface, having no need to utilize a pointing device such as a mouse, a pointing stick, a touchpad, or a touch screen. As a result of applying the present invention method, no related art problems will occur. In addition, the user can easily control movement of a cursor displayed on the screen, and more particularly, long distance movement thereof.

Those skilled in the art will readily observe that numerous modifications and alterations of the device and method may be made while retaining the teachings of the invention.

1. A method for providing a user with a fast control user interface, the method being applied to an electronic device, the method comprising:
providing the user with a plurality of keys/buttons for selecting one of a plurality of display regions on a screen, wherein each display region corresponds to at least one associated key/button of the keys/buttons; and when a specific key/button of the keys/buttons is pressed, selecting/highlighting a specific display region corresponding to the specific key/button for further operations.

2. The method of claim 1, further comprising:
providing the user with a set of keys/buttons for selecting one of a plurality of sub-regions of the specific display region, wherein the set of keys/buttons are not necessarily to be the same as the plurality of keys/buttons, and each sub-region corresponds to at least one associated key/button of the set of keys/buttons; and when a key/button of the set of keys/buttons is pressed, selecting/highlighting a specific sub-region corresponding to the key/button of the set of keys/buttons for further operations.

3. The method of claim 2, wherein the set of keys/buttons comprise at least one portion of the plurality of keys/buttons.

4. The method of claim 1, wherein the step of selecting/highlighting the specific display region corresponding to the specific key/button for further operations further comprises:
highlighting the specific display region corresponding to the specific key/button by highlighting one or more selectable items of the specific display region.

5. The method of claim 1, further comprising:
when the specific key/button is pressed, performing a zoom in operation by enlarging contents of the specific display region for the user's convenience.

6. The method of claim 1, further comprising:
with regard to the respective display regions, providing the user with associated visual indexes displayed on the screen, wherein the visual indexes respectively correspond to the keys/buttons.

7. The method of claim 6, wherein the visual indexes depict numbers, characters, and/or symbols represented by the keys/buttons, respectively.

8. The method of claim 6, wherein the visual indexes respectively depict colors of the keys/buttons, colors of respective surroundings of the keys/buttons, colors of labels of the keys/buttons, colors of marks of the keys/buttons, colors of light emitted from the keys/buttons, and/or colors of light emitted from respective surroundings of the keys/buttons.

9. The method of claim 1, wherein a geographic arrangement of the display regions corresponds to an arrangement of the keys/buttons.

10. The method of claim 1, wherein a geographic arrangement of the display regions corresponds to an arrangement of webpage contents displayed on the screen.

11. An electronic device, comprising:
a control circuit arranged to control operations of the electronic device and to provide a user with a fast control user interface; and an interface circuit arranged to receive signals directly/indirectly from a plurality of keys/buttons and to notify the control circuit of user activities accordingly, wherein the electronic device or at least one accessory thereof provides the user with the plurality of keys/buttons for selecting one of a plurality of display regions on a screen, and each display region corresponds to at least one associated key/button of the keys/buttons; wherein when a specific key/button of the keys/buttons is pressed, the control circuit selects/highlights a specific display region corresponding to the specific key/button for further operations.

12. The electronic device of claim 11, wherein the electronic device or the accessory thereof further provides the user with a set of keys/buttons for selecting one of a plurality of sub-regions of the specific display region, the set of keys/buttons are not necessarily to be the same as the plurality of keys/buttons, and each sub-region corresponds to at least one associated key/button of the set of keys/buttons; and when a key/button of the set of keys/buttons is pressed, the control circuit selects/highlights a specific sub-region corresponding to the key/button of the set of keys/buttons for further operations.

13. The electronic device of claim 12, wherein the set of keys/buttons comprise at least one portion of the plurality of keys/buttons.

14. The electronic device of claim 11, wherein when the specific key/button of the keys/buttons is pressed, the control circuit highlights the specific display region corresponding to the specific key/button by highlighting one or more selectable items of the specific display region.

15. The electronic device of claim 11, wherein when the specific key/button is pressed, the control circuit performs a zoom in operation by enlarging contents of the specific display region for the user's convenience.

16. The electronic device of claim 11, wherein with regard to the respective display regions, the control circuit provides the user with associated visual indexes displayed on the screen; and the visual indexes respectively correspond to the keys/buttons.

17. The electronic device of claim 16, wherein the visual indexes depict numbers, characters, and/or symbols represented by the keys/buttons, respectively.

18. The electronic device of claim 16, wherein the visual indexes respectively depict colors of the keys/buttons, colors of respective surroundings of the keys/buttons, colors of labels of the keys/buttons, colors of marks of the keys/buttons, colors of light emitted from the keys/buttons, and/or colors of light emitted from respective surroundings of the keys/buttons.

19. The electronic device of claim 11, wherein a geographic arrangement of the display regions corresponds to an arrangement of the keys/buttons.

20. The electronic device of claim 11, wherein a geographic arrangement of the display regions corresponds to an arrangement of webpage contents displayed on the screen.
